(19) United States
(12) Patent Application Publication
(10) Pub. No.: US 2026/0184066 A1
(43) Pub. Date: Jul. 2, 2026

(54) PRINTED MATTER AND METHOD OF MANUFACTURING PRINTED MATTER

(71) Applicant: Shuhou Co., Ltd., Fukui-shi, Fukui (JP)

(72) Inventor: Kouji MURAOKA, Sabae-shi, Fukui (JP)

(73) Assignee: Shuhou Co., Ltd., Fukui-shi, Fukui (JP)

(21) Appl. No.: 18/859,199

(22) PCT Filed: May 11, 2023
(86) PCT No.: PCT/JP2023/017669

§ 371 Date: Oct. 23, 2024

(51) Int. Cl. B41F 17/34; B41F 17/00

(52) U.S. Cl. CPC B41F 17/34; B41F 17/001

(57) ABSTRACT

An object is to obtain a printed matter in which a boundary of a print image including a plurality of print image regions is inconspicuous, and a method of manufacturing the printed matter. A printing apparatus is a printed matter formed by transferring ink placed on a printing surface of a printing pad through pressing the printing surface. The printed matter includes a base body and a print image region formed by placing the ink on a surface of the base body. The print image region includes two print image regions disposed adjacent to each other. Each of the two print image regions includes a peripheral edge facing the other of the two print image regions. The peripheral edge of each of the two print image regions has a curved shape including irregularities, and is disposed within a range of the other of the two print image regions.

### TECHNICAL FIELD

The present disclosure relates to a printed matter in which a print is applied on a surface of a base body, and a method of manufacturing the printed matter.

### BACKGROUND ART

A method of performing printing on a surface of a print-target material by use of a printing pad has been known. In the method, one picture to be printed is formed by performing a printing step a plurality of times, by dividing the one picture into a plurality of small pictures, and transferring ink corresponding to the small pictures, from an original plate to respective corresponding print regions by use of the printing pad (for example, see Patent Literature 1). This makes it possible to perform printing on a print-target material having a complicated shape.

### CITATION LIST

### Patent Literature

Patent Literature 1: Japanese Unexamined Patent Application Publication No. 2011-000736

### SUMMARY OF INVENTION

### Technical Problem

A problem is, however, presented with a picture to be printed being printed by being divided into a plurality of print image regions (small pictures) as disclosed in Patent Literature 1. The problem is that a gap is generated or two print images are overlapped at a boundary between two adjacent print image regions, and therefore the boundary is more conspicuous than other portions.

The present disclosure has been made to solve the above-described problem, and has as an object to obtain a printed matter in which boundaries in a print image including a plurality of print image regions are made inconspicuous, and a method of manufacturing the printed matter.

### Solution to Problem

A printed matter according to one embodiment of the present disclosure is a printed matter formed by transferring ink placed on a printing surface of a printing pad through pressing the printing surface. The printed matter includes a base body; and a print image region formed by placing the ink on a surface of the base body. The print image region includes two print image regions disposed adjacent to each other. Each of the two print image regions includes a peripheral edge facing the other of the two print image regions. The peripheral edge of each of the two print image regions has a curved shape including irregularities, and is disposed within a range of the other of the two print image regions.

A method of manufacturing a printed matter according to another embodiment of the present disclosure is a method including transferring ink placed on a printing surface of a printing pad through pressing the printing surface against a surface of a base body, and forming two print image regions at least disposed adjacent to each other on the surface of the base body. Each of the two print image regions includes a peripheral edge facing the other of the two print image regions. The peripheral edge has a curved shape including irregularities. The method includes: transferring the ink on a printing original plate to the printing surface by pressing the printing surface against the printing original plate on which the ink is placed; moving the printing pad in which the ink is transferred to the printing surface to above the base body; and pressing the printing surface against the surface of the base body through forming one of the two print image regions by aligning the printing surface with the surface of the base body and deforming the printing surface. The transferring, the moving, and the pressing are performed every time each of the two print image regions is formed. The pressing is performed such that the peripheral edge of each of the two print image regions is arranged within a range of the other of the two print image regions.

### Advantageous Effects of Invention

According to an embodiment of the present disclosure, when the two print image regions are formed on the surface of the base body, the peripheral edges of the two print image regions are in contact with each other, or the peripheral edge of each of the two print image regions is disposed in the other of the two print image regions. Each of the peripheral edges has the curved shape including irregularities. Therefore, even when the boundary is present in an image to be printed, the boundary is inconspicuous.

### BRIEF DESCRIPTION OF DRAWINGS

FIG. 1 is an explanatory diagram of a cross-sectional structure of a printed matter 70 according to Embodiment 1.

FIG. 2 illustrates examples of a connection region 75 in a print image region 71 of the printed matter 70 according to Embodiment 1.

FIG. 3 is a diagram illustrating relationship between a distance from a peripheral edge 74 of the connection region 75 illustrated in FIG. 2 and dot density of ink 41.

FIG. 4 is a diagram schematically illustrating a total value of an ink amount in a case where a connection region 75a and a connection region 75b illustrated in FIG. 3 are overlapped with each other.

FIG. 5 illustrates an example of a print image of the printed matter 70 according to Embodiment 1.

FIG. 6 illustrates an example of the print image of the printed matter 70 according to Embodiment 1.

FIG. 7 is an enlarged schematic view of the print image region 71 according to Embodiment 1.

FIG. 8 is an enlarged schematic view of the print image region 71 according to Embodiment 1.

FIG. 9 is a side view illustrating an example of a printing apparatus 100 according to Embodiment 1.

FIG. 10 is a cross-sectional view illustrating an example of a printing pad 10 provided in the printing apparatus 100 according to Embodiment 1.

FIG. 11 illustrates a workflow of a method of manufacturing a printed matter by the printing apparatus 100 according to Embodiment 1.

FIG. 12 illustrates a workflow of operation of the printing apparatus 100 according to Embodiment 1.

FIG. 13 illustrates a modification of the printing pad 10 used in the printing apparatus 100 according to Embodiment 1.

### DESCRIPTION OF EMBODIMENTS

### Embodiment 1

A printed matter and a method of manufacturing the printed matter according to the present disclosure are described below with reference to drawings. The present disclosure is not limited by an embodiment described below. In the drawings, the same components are denoted by the same reference signs, and description of a part of the components is omitted. The drawings are schematically drawn, and the present disclosure is not limited to illustrated shapes.

### Printed Matter 70

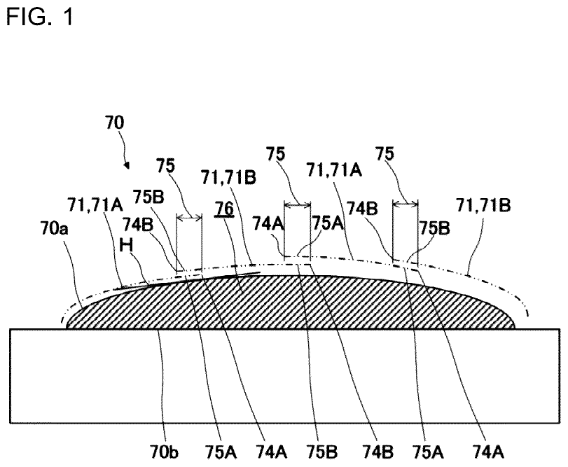

FIG. 1 is an explanatory diagram of a cross-sectional structure of a printed matter 70 according to Embodiment 1. The printed matter 70 is an item in which a plurality of print image regions 71 are formed on at least one surface 70a of a base body 76 that is, for example, a resin molded product. The print image regions 71 of the printed matter 70 form, for example, a predetermined pattern, a picture, and colors. Further, for example, the print image regions 71 may be formed on a resin molded product forming an exterior cover of an illumination apparatus such as a tail lamp and a headlight of an automobile, thereby preventing transmission of light. Note that a shape of the printed matter 70 illustrated in FIG. 1 is illustrative, and shapes of surfaces 70a and 70b can be appropriately changed.

Alternate long and two short dashes lines illustrated in FIG. 1 indicate the plurality of print image regions 71. The alternate long and two short dashes lines are illustrated separately from the surface 70a of the base body 76 of the printed matter 70, but the plurality of print image regions 71 are actually regions on the surface 70a, and aggregations of ink 41 are disposed on the plurality of print image regions 71. In the printed matter 70 illustrated in FIG. 1, as an example, four print image regions 71 are disposed on the surface 70a. Peripheral edges 74A and 74B of two adjacent print image regions 71A and 71B are each disposed within a range of the other of the print image regions 71A and 71B. In other words, in the two adjacent print image regions 71A and 71B, the peripheral edge 74A and the peripheral edge 74B are in contact with each other, or a partial region including the peripheral edge 74A and a partial region including the peripheral edge 74B are overlapped with each other. An end region including the peripheral edge 74A of the print image region 71A is referred to as a connection region 75A. Likewise, an end region including the peripheral edge 74B of the print image region 71B is referred to as a connection region 75B. The peripheral edges 74A and 74B may be collectively referred to as peripheral edges 74. The connection regions 75A and 75B may be collectively referred to as connection regions 75.

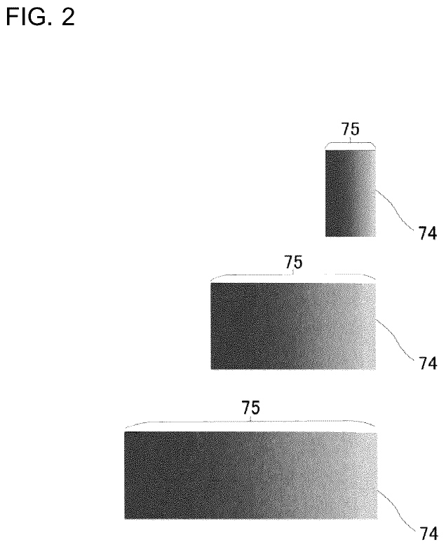

FIG. 2 illustrates examples of the connection regions 75 of the print image regions 71 of the printed matter 70 according to Embodiment 1. The connection regions 75 are specified such that, for example, an amount of ink per unit area is gradually increased from the peripheral edges 74 to centers of the respective print image regions 71.

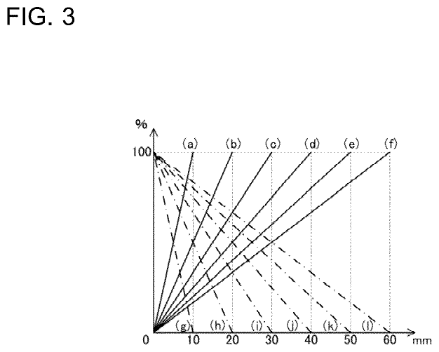

FIG. 3 is a diagram illustrating relationship between a distance from the peripheral edge 74 of each of the connection regions 75 illustrated in FIG. 2 and dot density of the ink 41. The connection regions 75 are specified such that the ink amount is gradually increased from the peripheral edges 74 toward the centers of the respective print image regions 71. In FIG. 3, the connection regions 75 are specified such that the ink amount at the centers of the respective print image regions 71 is 100% and the ink amount at the peripheral edges 74 is 0%. Solid lines (a) to (f) illustrated in FIG. 3 each indicate density of the ink 41 in the connection region 75A of the print image region 71A that is one of the two adjacent print image regions. On the other hand, alternate long and short dash lines (g) to (I) illustrated in FIG. 3 each indicate density of the ink 41 in the connection region 75B of the print image region 71B, which is the other of the two adjacent print image regions.

The two adjacent print image regions 71A and 71B are specified such that gradients of dot densities of the ink 41 in the connection regions 75 are represented by, for example, a combination of the solid line (a) and the alternate long and short dash line (g). In other words, change in dot density of the ink 41 relative to the distance from the peripheral edge 74 of the connection region 75 of the print image region 71A is specified substantially the same as change in dot density of the ink 41 relative to the distance from the peripheral edge 74 of the connection region 75 of the print image region 71B. When the two connection regions 75 are overlapped with each other, the dot density of the ink 41 in the overlapped connection regions 75 has a small difference from the dot density of the ink 41 at the center of each of the print image regions 71, and a boundary L between the two print image regions 71 is inconspicuous. At this time, the print image regions 71A and 71B are printed to be ideally overlapped with each other by the width same as the width of the connection regions 75.

Note that the graph of change in dot density of the ink 41 in each of the connection regions 75 illustrated in FIG. 3 illustrates a percentage of the ink amount when the ink amount at the center is defined as 100%; however, the image formed in the print image regions 71 is not limited to a uniform pattern with a single color as illustrated in FIG. 2. The image formed in the print image regions 71 may be a multicolor nonuniform pattern such as a wood-grain pattern, a painting, and a photograph. In a case where a nonuniform pattern or another similar pattern is formed in the print image regions 71, the percentage [%] of the ink amount illustrated in FIG. 3 indicates the percentage of the ink amount relative to an original image while a state where each of the connection regions 75 is printed with the ink amount similar to the ink amount at the center is defined as 100%. In other words, in Embodiment 1, the connection region 75 of each of the two adjacent print image regions 71 is specified such that the image is gradually made light toward the peripheral edge 74 as compared with the original image.

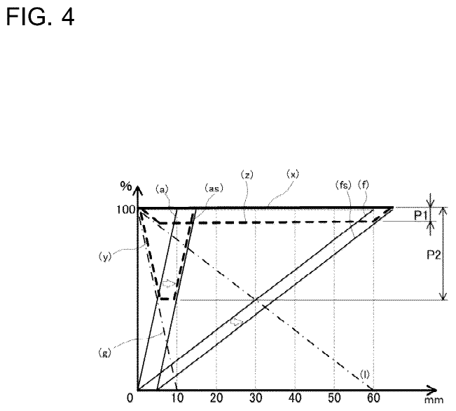

FIG. 4 is a diagram schematically illustrating a total value of the ink amounts in a case where the connection region 75a and the connection region 75b illustrated in FIG. 3 are overlapped with each other. For example, in a case where the connection region 75a indicated by the solid line (f) and the connection region 75b indicated by the alternate long and short dash line (I) are overlapped with each other, the total ink amount of the overlapped connection regions 75 is substantially uniform over the entire regions as indicated by a thick solid line (x). For example, even in a case where the connection region 75a indicated by the solid line (a) and the connection region 75b indicated by the alternate long and short dash line (g) are overlapped with each other, the total ink amount of the overlapped connection regions 75 is substantially uniform over the entire regions as indicated by the thick solid line (x).

In actuality, the plurality of adjacent print image regions 71 have an error in arrangement position. Therefore, in each of the connection regions 75, the dot density of the ink 41 may not be completely uniform unlike an example indicated by the solid line (x) illustrated in FIG. 3.

A solid line (fs) illustrated in FIG. 4 indicates, in a case where one of the two adjacent print image regions 71 is printed at a position shifted from an original position, change in dot density of the ink 41 in its connection region 75 relative to the distance from its peripheral edge 74. As an example, the solid line (fs) indicates a state where one of the two adjacent print image regions 71 is shifted by 5 mm from an original ideal position. In other words, the solid line (fs) indicates a case where the two connection regions 75 are overlapped with each other by 55 mm even though the two connection regions 75 are formed such that the two connection regions 75 are originally overlapped with each other by 60 mm. At this time, the connection region 75A indicated by the solid line (fs) and the connection region 75B indicated by the alternate long and short dash line (I) are overlapped with each other, which results in dot density distribution of the ink 41 indicated by a dashed line (z). Thus, a region having small dot density of up to about 8% is generated.

A solid line (as) illustrated in FIG. 4 indicates, in the case where one of the two adjacent print image regions 71 is printed at a position shifted from an original position, change in dot density of the ink 41 in its connection region 75 relative to the distance from its peripheral edge 74. As an example, the solid line (as) indicates a state where one of the two adjacent print image regions 71 is shifted by 5 mm from an original ideal position. In other words, the solid line (as) indicates a case where the two connection regions 75 are overlapped with each other by 5 mm even though the two connection regions 75 are formed such that the two connection regions 75 are originally overlapped with each other by 10 mm. At this time, the connection region 75A indicated by the solid line (as) and the connection region 75B indicated by the alternate long and short dash line (g) are overlapped with each other, which results in dot density distribution of the ink 41 indicated by a dashed line (y). Thus, a region having small dot density of up to about 50% is generated.

As can be seen from comparison between the case of the solid line (fs) and the case of the solid line (as) illustrated in FIG. 4, each of the connection regions 75 desirably has a wide width, and the gradient of the change in dot density of the ink 41 is desirably gentle. As with the solid line (fs) illustrated in FIG. 4, when the relatively large connection regions 75 are provided and overlapped regions of the two adjacent print image regions 71 are made large, it is possible to prevent the change in dot density of the ink 41 in the vicinity of the boundary L between the two adjacent print image regions 71. As a result, for example, even in the printed matter 70 manufactured by combining the plurality of print image regions 71 by performing the print steps a plurality of times as illustrated in FIG. 1, quality of the print image is improved.

As an example, in the printed matter 70 illustrated in FIG. 1, a width of one print image region 71 is about 500 mm, and a width of one connection region 75 is about 30 mm. This is because a maximum possible range of one print image region 71 is determined depending on a printing apparatus 100, a size of a printing pad 10, or a size of a printing original plate 50.

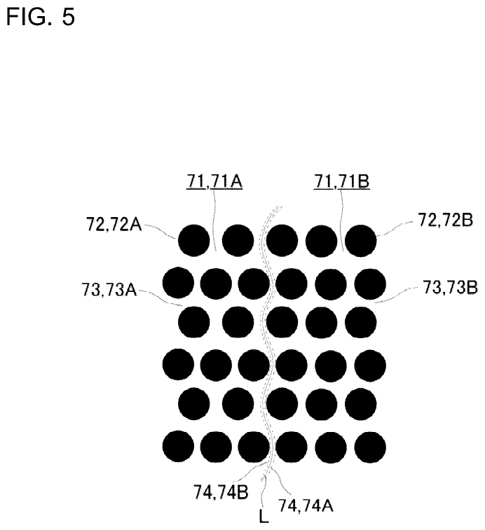

FIG. 5 illustrates an example of the print image of the printed matter 70 according to Embodiment 1. The print image illustrated in FIG. 5 includes first regions 72 where an amount of ink 41 per unit area is relatively large, and a second region 73 where an amount of ink 41 per unit area is relatively small. The amount of ink 41 per unit area in each of the first regions 72 is greater than the amount of ink 41 per unit area in the second region 73. The plurality of first regions 72 are provided and are each surrounded by the second region 73. The print image illustrated in FIG. 5 includes two print image regions 71A and 71B, and the boundary L between the two print image regions 71A and 71B is disposed such that the boundary L avoids first regions 72A and 72B. In other words, the peripheral edges 74 of the print image regions 71 are disposed in the second region 73. Note that a region where the amount of ink 41 is relatively small in the print image region 71A is referred to as a second region 73A, and a region where the amount of ink 41 is relatively small in the print image region 71B is referred to as a second region 73B.

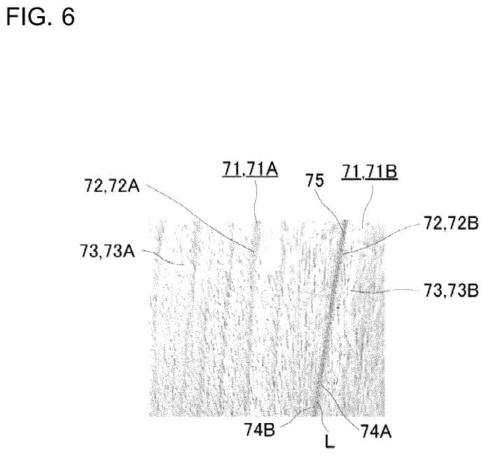

FIG. 6 illustrates an example of the print image of the printed matter 70 according to Embodiment 1. The print image illustrated in FIG. 6 is a wood-grain pattern. The first regions 72 with relatively dark colors and the second regions 73 with relatively light colors extend in a vertical direction of the drawing, and are alternately arranged to form a stripe pattern. The print image illustrated in FIG. 6 includes the two print image regions 71A and 71B, and the boundary L between the two print image regions 71A and 71B is disposed in one of the first regions 72. In other words, the peripheral edges 74 of the two print image regions 71 are both disposed in one of the first regions 72. The peripheral edges 74A and 74B of the two print image regions 71A and 71B are each formed in a curved shape having irregularities, and are each disposed within a range of the other of the two print image regions 71A and 71B. The boundary L is disposed along the stripe pattern. Therefore, the boundary L is disposed in one of the first regions 72 with the dark colors, and is accordingly inconspicuous. In addition, each of the connection regions 75 including the peripheral edges 74 of the print image regions 71A and 71B is specified such that the dot density of the ink 41 is gradually increased toward the center as illustrated in FIG. 2. This makes the boundary L more inconspicuous.

The boundary L between the print image regions 71A and 71B may be provided in one of the second regions 73 with relatively light colors. In any case, the boundary L is disposed in one of the first regions 72 and the second regions 73, and is disposed along one of the region where the colors of the stripe pattern are dark and the region where the colors of the stripe pattern are light. This makes it possible to make the boundary L inconspicuous.

### Detailed Structure of Print Image Region 71

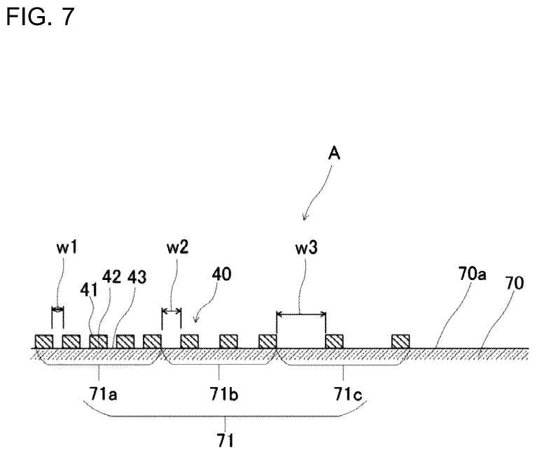

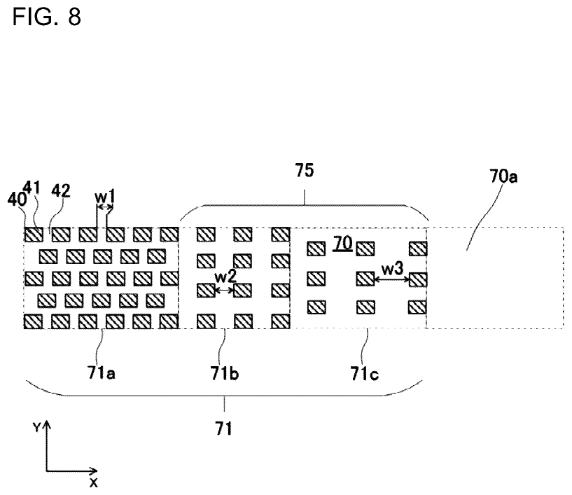

FIG. 7 and FIG. 8 are enlarged schematic views of one print image region 71 according to Embodiment 1. FIG. 7 is a schematic cross-sectional view in a case where the ink 41 is disposed in dots on the one surface 70a of the printed matter 70. FIG. 8 is a diagram of the print image region 71 illustrated in FIG. 7 in a planar view. The print image region 71 is formed by placing the ink 41 on the one surface 70a of the printed matter 70. A region where the ink 41 is placed on one surface 70a of the printed matter 70 is referred to as the print image region 71. The surface 70a on which the print image region 71 is disposed includes first portions 42 that are surface portions on which the ink 41 is placed, and second portions 43 that are surface portions on which no ink 41 is placed.

The print image region 71 may include a plurality of print image regions 71a, 71b, and 71c different in arrangement density of the first portions 42 on which the ink 41 is placed. In the print image region 71a positioned on the leftmost side illustrated in FIG. 7, the ink 41 is arranged at intervals w1 in a cross-section. In the print image region 71b disposed on the right of the print image region 71a, the ink 41 is arranged at intervals w2. In the print image region 71c disposed on the right of the print image region 71b, the ink 41 is arranged at intervals w3. The print image regions 71a, 71b, and 71c are different in arrangement interval of the ink 41, and the intervals are set to satisfy w1<w2<w3. The print image region 71 is not limited to a form in which the dots of the ink 41 are distributed as with the print image regions 71a, 71b, and 71c, and the ink 41 may be arranged over the entire predetermined region. The plurality of print image regions 71a, 71b, and 71c are different in arrangement density of the ink 41. In addition, in each of the plurality of print image regions 71a, 71b, and 71c, the ink 41 is arranged with substantially uniform density. In other words, an area where the ink 41 is arranged is equal among the plurality of print image regions 71a, 71b, and 71c when any part having a predetermined area in each of the regions is observed. A non-print region is a region where no ink 41 is arranged, in other words, a region where the arrangement density of the ink 41 is zero.

In each of the print image regions 71a, 71b, and 71c, the ink 41 (first portions) is arranged in an x direction and a y direction. The number of arrangements of the ink 41 per unit area, namely, the arrangement density is different among the print image regions 71a, 71b, and 71c. As illustrated in FIG. 8, the arrangement density of the ink 41 in the print image region 71a is higher than the arrangement density of the ink 41 in each of the print image region 71b and the print image region 71c. In addition, the arrangement density of the ink 41 in the print image region 71b is higher than the arrangement density of the ink 41 in the print image region 71c. When a certain part of the print image region 71 is referred to as a first print region, a part of the print image region 71 lower in arrangement density of the ink 41 than the first print region may be referred to as a second print region. In other words, the printed matter 70 according to Embodiment 1 includes the print image regions 71, and each of the print image regions 71 includes the plurality of print image regions 71a, 71b, and 71c different in arrangement density of the ink 41 in some cases. The plurality of print image regions 71a, 71b, and 71c include the first print region higher in arrangement density of the first portions 42 than the second print region. In other words, the second print region is higher in density of the second portions 43 on which no ink 41 is placed than the first print region.

The printed matter 70 according to Embodiment 1 may include the plurality of print image regions 71a, 71b, and 71c different in arrangement density of the ink 41, and for example, each of the connection regions 75 including the peripheral edge 74 as illustrated in FIG. 2 to FIG. 4 may be formed by the plurality of print image regions 71a, 71b, and 71c different in arrangement density of the ink 41. In a case where the plurality of print image regions 71 are formed on the printed matter 70, the plurality of print image regions 71 may be formed by performing a printing step a plurality of times, and the printing may be performed while the second print regions low in arrangement density of the ink 41 are overlapped with each other. For example, the printed matter 70 illustrated in FIG. 1 is printed such that the print image region 71b that is a part of the one print image region 71A and the print image region 71c that is a part of the other print image region 71B are overlapped with each other, and the print image region 71c that is a part of the one print image region 71A and the print image region 71b that is a part of the other print image region 71B are overlapped with each other. The entire image formed by combining the two print image regions 71 has wholly uniform arrangement density of the ink 41 because of overlapping of the print image regions 71b and 71c different in arrangement density of the ink 41. In other words, the print image regions 71 described here are used in a case where the print image regions 71 formed on the printed matter 70 are formed by performing the printing step a plurality of times, namely, a case where a print range is wide, a case where a surface shape of the printed matter 70 is complicated, and other cases. As a result, no gap is generated between the adjacent print image regions 71, and the print image regions 71 can be formed without unevenness as a whole. In other words, positional variation in printing of the print image regions 71 caused by performing the printing step a plurality of times can be absorbed by overlapping the print image regions 71b and 71c low in arrangement density of the ink 41, which makes it possible to form the print image regions 71 without unevenness as a whole.

In a case where, among the plurality of print image regions 71, each of the two adjacent print image regions 71 has the arrangement structure of the ink 41, for example, as illustrated in FIG. 7 and FIG. 8, the print image region 71a not overlapped is referred to as the first print region, and the print image regions 71b and 71c overlapped in the above description are referred to as the second print regions. In other words, each of the two adjacent print image regions 71 includes the second print region low in arrangement density of the ink 41 such as the print image regions 71b and 71c, at a peripheral edge of the print image region 71, and the second print regions of the two adjacent print image regions 71 are overlapped with each other, which enables printing while the boundary between the two print image regions 71 is inconspicuous. The second print region may include a plurality of print image regions different in arrangement density of the ink 41 such as the print image regions 71b and 71c, or may include more print image regions. The second print region is not limited to a region where the arrangement density of the ink 41 is changed in a stepwise manner as illustrated in FIG. 7 and FIG. 8, and may be a region where the arrangement density of the ink 41 is continuously reduced from the center to the peripheral edge of the print image region 71.

In a case where a visible surface has a three-dimensional surface structure as with the base body 76 of the printed matter 70 as illustrated in FIG. 1, a portion in which the second print regions of the two adjacent print regions are overlapped as described above is desirably disposed at a position where the ink 41 can be transferred from the printing pad 10 as accurate as possible. Therefore, the portion in which the second print regions are overlapped is preferably disposed such that the portion includes a position including a tangent perpendicular to a pressing direction of the printing pad 10 in a cross-section parallel to the pressing direction in the three-dimensional structure. In FIG. 1, for example, in a case where the print image regions 71A and 71B are overlapped, the connection region 75 at the center is most preferable. A tangent H of the surface on which the connection region 75 is disposed is desirably perpendicular to the pressing direction of the printing pad 10, but in practice, the connection region 75 may be disposed within a range where the tangent H forms an angle of 0 degrees to 30 degrees to the surface perpendicular to the pressing direction. In other words, the connection regions 75 positioned on the leftmost side and the rightmost side in FIG. 1 have no problem in practice. When the angle of the tangent H of the portion in which the connection region 75 is disposed to the surface perpendicular to the pressing direction is large, the base body 76 may be inclined such that the tangent H is substantially perpendicular to the pressing direction of the printing pad.

In Embodiment 1, the ink 41 is illustrated as the rectangular dots in a planar view; however, the ink 41 is schematically illustrated, and the ink 41 may actually be formed in a circular shape or a shape close to the circular shape in a planar view. In FIG. 7 and FIG. 8, the ink 41 is also illustrated in the rectangular shape; however, the ink 41 is also schematically illustrated, and the ink 41 may actually have a rounded shape, for example, a shape of a droplet placed on a surface having water repellency.

In each of the print image regions 71a, 71b, and 71c, the arrangement density of the ink 41 is uniform; however, the arrangement density of the ink 41 is not limited to this arrangement density. For example, the arrangement density of the ink 41 may be continuously changed such that the arrangement density is gradually reduced from the left to the right in FIG. 8.

### Printing Apparatus 100

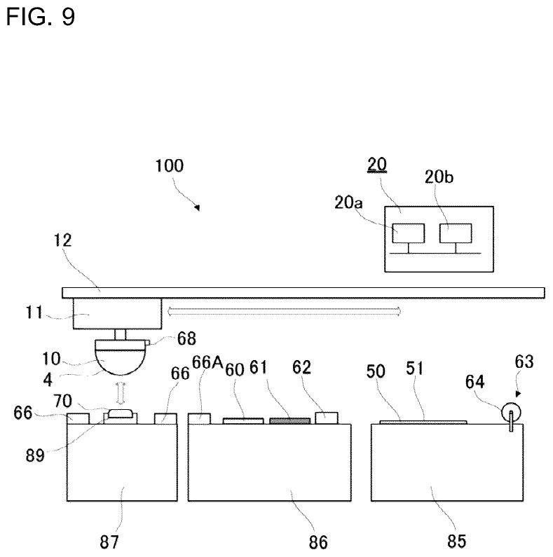

FIG. 9 is a side view schematically illustrating an example of the printing apparatus 100 according to Embodiment 1. The printing apparatus 100 includes the printing pad 10 that is linearly movable in the vertical direction. The printing pad 10 is vertically moved by a vertically moving device 11 provided in the printing apparatus 100 and presses a printing surface 4 against a surface to be printed of the printed matter 70. In Embodiment 1, the surface to be printed is the surface 70a. The printing apparatus 100 further includes a horizontally moving device 12. The horizontally moving device 12 moves the printing pad 10 and the vertically moving device 11 in a horizontal direction.

The printing pad 10 is moved, by the horizontally moving device 12, to a position above a cleaning device 60, an activation device 61, an air blowing device 62, and the printing original plate 50 in addition to the printed matter 70. The printing pad 10 is vertically moved by the vertically moving device 11, and the printing surface 4 is pressed against each of the printed matter 70, the cleaning device 60, the activation device 61, and the printing original plate 50. In FIG. 9, the printing apparatus 100 includes a printing stage 87 on which the printed matter 70 is placed, a surface treatment stage 86 including the cleaning device 60, and a printing original plate stage 85 in order from the left. The surface treatment stage 86 includes the activation device 61 and the air blowing device 62. The printing original plate 50 is placed on the printing original plate stage 85. However, in the printing apparatus 100, these stages can be freely arranged, and can be appropriately changed depending on convenience of a worker and a location where the printing apparatus 100 is installed. The cleaning device 60, the activation device 61, the air blowing device 62, and blowers 66 and 66A may not be installed in the printing apparatus 100.

### Printing Pad 10

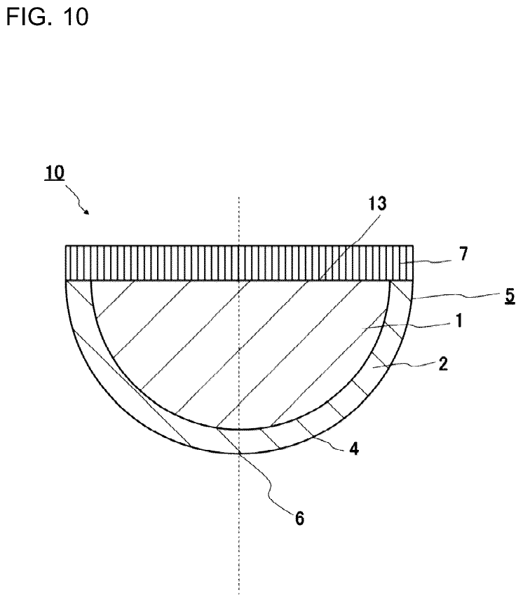

FIG. 10 is a cross-sectional view illustrating an example of the printing pad 10 provided in the printing apparatus 100 according to Embodiment 1. FIG. 10 illustrates a cross-section that passes through an apex 6 of the printing pad 10 and is perpendicular to a flat surface 13 to which a base 5 is fixed. As illustrated in FIG. 10, the base 5 of the printing pad 10 includes an internal layer 1 and an external layer 2 covering a surface of the internal layer 1. The printing pad 10 illustrated in FIG. 10 has, for example, a substantially hemispherical shape. The shape of the printing pad 10 is not limited to the substantially hemispherical shape, and can be appropriately changed to, for example, a cannonball shape, a shape having a curved surface obtained by rotating a parabola about a symmetrical axis of the parabola, a shape such as a portion obtained by cutting an ellipsoid, or a shape obtained by continuously extending a cross-section of a cannonball shape or a semicircular shape on a straight line, in accordance with a specification and other properties of the printed matter 70. The printing pad 10 includes the apex 6 that first comes into contact with the printed matter 70 or the printing original plate 50, and the apex 6 has a point shape or a line shape. Therefore, when the printing pad 10 is pressed against the printed matter 70 or the printing original plate 50, the printing pad 10 does not catch air between the printing surface 4 and the printed matter 70 and between the printing surface 4 and the printing original plate 50. This makes it possible to prevent a void from being generated in the print image printed on the printed matter 70. In Embodiment 1, within the surface of the printing pad 10, a predetermined range centered around the apex 6 serves as the printing surface 4 that receives the ink from the printing original plate 50 and transfers the ink to the printed matter 70.

FIG. 1 illustrates a case where the printing pad 10 forms one print image region 71 on the printed matter 70 by performing the printing step one time. The printing step is performed four times to manufacture the printed matter 70.

### Base 5

The base 5 is formed by molding, for example, a silicone rubber. The base 5 has elasticity (flexibility), and is mixed with silicone oil for facilitating deformation. In Embodiment 1, the base 5 has a substantially hemispherical shape, but the shape can be appropriately changed in accordance with the specification and other properties of the printed matter 70. The base 5 is deformed when the printing pad 10 is pressed against the printing original plate 50, and receives the ink 41 placed on a placement surface 51 of the printing original plate 50 by the printing surface 4. The ink 41 placed on the placement surface 51 of the printing original plate 50 is arranged corresponding to an image to be printed on the printed matter 70, and forms a print pattern corresponding to the image. A material of the base 5 is not limited as long as the base 5 can transfer the ink 41 to the surface to be printed when the printing pad 10 is pressed against the surface to be printed.

For example, the base 5 may be made of two materials different in hardness. In this case, for example, a material of the external layer 2 forming a portion closer to the printing surface 4 than is the internal layer 1 is set to have Asker-C hardness within a range from 5 points to 20 points. A material of the internal layer 1 inside the external layer 2 is set to have Asker-C hardness within a range from 20 points to 40 points. The internal layer 1 is positioned on a face on which force for pressing the printing surface 4 against the surface to be printed is applied in printing, and is positioned closer to a supporting part 7 than is the external layer 2. The supporting part 7 is connected to the vertically moving device 11, and transfers force from the vertically moving device 11 to the printing pad 10. In FIG. 10, an upper portion of the base 5 is set to have Asker-C hardness within a range from 20 points to 40 points, and a lower portion of the base 5 (on a face on which apex 6 is positioned) is set to have Asker-C hardness within a range from 5 points to 20 points. To deform the printing pad 10 for aligning the printing pad 10 with the surface to be printed, hardness of the printing pad 10 is desirably set low. Therefore, hardness of a portion of the printing pad 10 closer than is the upper portion to the printing surface 4 to be pressed against the printed matter 70 is set lower than hardness of the upper portion. Such a configuration enables the entire shape of the printing pad 10 to be easily maintained. In addition, the external layer 2 directly pressed against the surface to be printed is advantageously easily deformed to a solid shape of the surface to be printed. However, hardness of each of the portions of the base 5 is not limited to the above-described hardness.

### Cleaning Device 60

As illustrated in FIG. 9, the surface treatment stage 86 is disposed next to the printing stage 87 of the printing apparatus 100. The cleaning device 60 is installed on the surface treatment stage 86. The cleaning device 60 includes, for example, paper or an adhesive tape. The printing surface 4 of the printing pad 10 is pressed against a surface of the paper or the adhesive tape, and the ink 41, stains, dusts, and other substances remaining after printing are thus removed.

### Activation Device 61

The activation device 61 includes a storage tank storing liquid, and an absorption unit absorbing and holding the liquid. When the printing surface 4 of the printing pad 10 is pressed against a surface of the absorption unit, the liquid held by the absorption unit adheres to the printing surface 4 of the printing pad 10. When water or a solvent is caused to adhere to or permeate into the base 5, the printing pad 10 easily transfers the ink 41 placed on the printing original plate 50 to the printing surface 4. The liquid is appropriately selected depending on properties with components contained in the ink 41, and has properties for softening the hard ink 41. The ink 41 is a mixture of a synthetic resin such as an acrylic resin and a urethane resin, and water, thinner, xylene, toluene, or other substance. The liquid having high affinity for the solvent contained in the ink 41 is preferably selected. However, the liquid used for the activation device 61 is not only limited to the above-described liquid.

The absorption unit of the activation device 61 is formed by, for example, absorbers stacked with each other and each having a thin sheet shape. The absorbers are made of, for example, paper, but is not only limited to the paper. The absorbers may be made of other material such as a cloth and a resin as long as the absorbers absorb the liquid. For example, the absorption unit may be a unit in which pieces of paper are stacked on a sponge resin. In some cases, stains such as the ink 41 remaining on the printing surface 4 of the printing pad 10 adheres to the surface of the absorption unit against which the printing surface 4 of the printing pad 10 is pressed, or the paper forming the absorption unit is torn because of rubbing of the surface of the absorption unit. Therefore, the absorption unit is formed such that the paper positioned on the uppermost layer of the absorption unit can be peeled and removed from the uppermost layer of the absorption unit, and the stacked pieces of paper can be removed one by one or an upper layer portion can be mechanically replaced. However, a method of replacing the paper positioned on the uppermost layer is not only limited to the method. The absorption unit is formed such that the paper forming the uppermost layer is removable or replaceable, and the surface of the absorption unit is constantly maintained clean and is impregnated with the liquid. Therefore, the printing surface 4 of the printing pad 10 can be activated by being pressed against the absorption unit.

### Air Blowing Device 62

The air blowing device 62 adjusts an amount of the water or the solvent adhering to the printing surface 4 of the printing pad 10 by the activation device 61 to an appropriate amount. The air blowing device 62 blows air toward the printing surface 4 and thus removes excess water or an excess solvent from the printing surface 4. Note that a system, the number, and an air blowing direction of the air blowing devices 62 are not limited.

### Printing Original Plate Stage 85

The printing original plate stage 85 includes a top surface on which the printing original plate 50 is placed, and an ink placement device 63 placing the ink on the printing original plate 50. For example, the ink placement device 63 includes a roller 64 holding the ink, and the roller 64 is rotated on the printing original plate 50 and thus places the ink on the printing original plate 50. The ink placement device 63 may be a head of an inkjet system installed such that the head is movable in the horizontal direction. In this case, the head places the ink on the surface of the printing original plate 50 by the inkjet system, and is configured to be movable along a moving rail. The ink placement device 63 is not limited to the above-described configuration, and may adopt other configuration.

### Method of Manufacturing Printed Matter by Use of Printing Apparatus 100

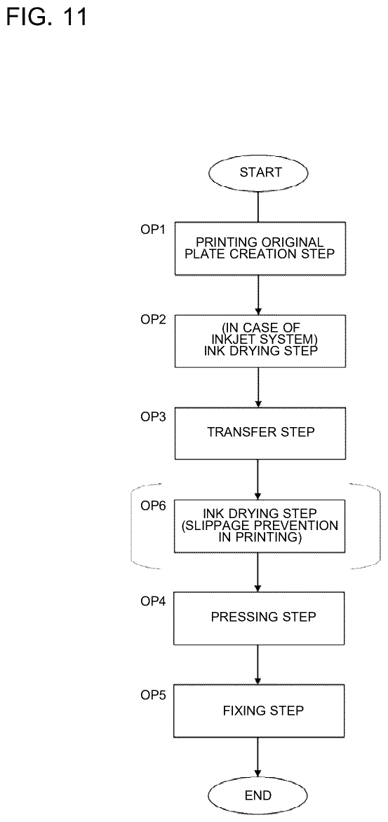

FIG. 11 illustrates a workflow of a method of manufacturing the printed matter by the printing apparatus 100 according to Embodiment 1. In the following, the method of manufacturing the printed matter by the printing apparatus 100 is described with reference to FIG. 9 and FIG. 11. As illustrated in FIG. 9, the printing apparatus 100 includes a controller 20. The controller 20 is, for example, a microcomputer, and includes a calculation device 20a, and a storage device 20b. Functions of the controller 20 are implemented by use of the calculation device 20a and the storage device 20b (see FIG. 9).

The storage device 20b is a ROM previously holding programs, data, and other pieces of information, a RAM temporarily storing data during execution of the programs, and other memories. Further, as the storage device 20b, a nonvolatile or volatile semiconductor memory such as a flash memory, an erasable and programmable ROM (EPROM), and an electrically erasable and programmable ROM (EEPROM) is used. Further, as the storage device 20b, for example, a detachable recording medium such as a magnetic disk, a flexible disk, an optical disc, a compact disc (CD), a mini disc (MD), and a digital versatile disc (DVD) may be used. The storage device 20b can store information obtained from a temperature sensor 68 and another similar device, and information processed by the calculation device 20a.

The calculation device 20a performs various kinds of processing for executing the functions of the controller 20. For example, the calculation device 20a compares information on a room temperature through a temperature sensor or another similar device with a threshold of a temperature previously stored in the storage device 20b and thus determines whether the room temperature is higher than the threshold. In a case where the room temperature is higher than the threshold, the controller 20 performs control such that output of a heater included in the blower 66 is reduced to a predetermined value. Alternatively, in the case where the room temperature is higher than the threshold, the controller 20 may perform control such that an operation time of the blower 66 is shortened. Further alternatively, the controller 20 may perform control such that a time is limited in which the printing pad 10 stops in front of the blower 66 and receives the air.

### Printing Original Plate Creation Step Op1

As illustrated in FIG. 11, in the method of manufacturing the printed matter, a printing original plate creation step OP1 of forming a print image on the placement surface 51 of the printing original plate 50 is first performed. As illustrated in FIG. 9, the printing original plate 50 has a flat plate shape, and is placed on the printing original plate stage 85. In Embodiment 1, the printing original plate 50 is a thin flat plate made of an aluminum alloy. A resin layer of the surface of the printing original plate 50 includes, for example, a layer repelling the ink and a layer accepting the ink, and the print image is created by distribution of a portion in which the layer accepting the ink is exposed. The ink placement device 63 may be configured to be movable in the horizontal direction and through at least above the printing original plate 50 by an unillustrated feeding device. Alternatively, the printing original plate 50 may be configured to be movable from and to the ink placement device 63. As illustrated in FIG. 1, even in a case where offset printing is performed on the printed matter 70 having a curved surface, the printing original plate creation step OP1 is performed in a similar manner. In a case of printing by the inkjet system, a sheet material that is called a “design receiving sheet” and is excellent in holding property and affinity for UV ink can be used. In addition, providing irregularities on the sheet material makes it possible to increase the holding property and affinity for the ink. The surface of the printing original plate 50 is finished with predetermined surface roughness. The printing apparatus 100 by the inkjet system obtains the print image by discharging fine ink droplets from nozzles provided in a head as the ink placement device 63 and blowing the fine ink droplets to the printing original plate 50. The head includes, in addition to storage units and nozzles for four colors, for example, red, blue, yellow, and black, storage units storing intermediate color ink of intermediate colors of the four colors, and nozzles from which the intermediate color ink is discharged. The head may be configured to arrange dots of the ink of at least five different colors including the intermediate color to the surface of the printing original plate 50.

### Ink Drying Step Op2

After the printing original plate creation step OP1 is finished, an ink drying step OP2 is performed. The ink drying step OP2 is performed in a case of printing by the inkjet system. The ink drying step OP2 may be omitted, or a step of drying the ink 41 transferred to the surface of the printing pad 10 may be provided between a transfer step OP3 and a pressing step OP4, in place of the ink drying step OP2. Immediately after the printing original plate creation step OP1 is finished, the ink 41 on the printing original plate 50 is low in viscosity. When the viscosity of the ink 41 on the printing original plate 50 remains low, the ink 41 is crushed and is not transferred with high accuracy when the printing pad 10 is pressed against the ink 41 on the printing original plate 50. In addition, accuracy of the print image is lowered because of bleeding of the ink 41 and other cause. Therefore, in the ink drying step OP2, the solvent contained in the ink 41 is evaporated and the viscosity of the ink 41 is thus increased.

In the ink drying step OP2, the solvent in the ink 41 is evaporated by sending air to or heating the ink 41 on the printing original plate 50. Alternatively, for example, the ink 41 may be naturally dried for a predetermined time while the printing original plate 50 is placed on the printing original plate stage 85. The solvent is higher in volatility than the other components in the ink 41. The solvent is evaporated from the ink 41 by sending air or other means and thus increases a ratio of the components other than the solvent in the ink 41, thereby increasing the viscosity of the ink. At completion of the ink drying step OP2, the viscosity of the ink 41 is adjusted to, for example, 3 Pa·s to 1,000 Pa·s. An ink drying time is desirably made coincident with a time necessary for each of the subsequent transfer step OP3 and pressing step OP4. Such a configuration makes it possible to continuously and efficiently print a number of printed matters 70.

The step may proceed from the printing original plate creation step OP1 to the ink drying step OP2 after the printing original plate 50 is moved from the printing original plate stage 85 or while the printing original plate 50 is still placed on the printing original plate stage 85. In a case where the printing original plate 50 is moved from the printing original plate stage 85, another printing original plate 50 can be immediately placed on the printing original plate stage 85, and the printing original plate creation step OP1 can be started. Therefore, a cycle time of the entire offset printing steps can be advantageously reduced.

The ink 41 on the printing original plate 50 may be dried in such a manner that, for example, a blower and a heater are installed next to the ink placement device 63, and the air having passed through the heater is sent onto the printing original plate 50 by the blower. A temperature of the heater installed together with the blower is set to a temperature as high as possible and lower than a boiling point of the solvent contained in the ink 41. As the solvent contained in the ink 41, a solvent that is half dried in the ink drying step OP2 is selected. For example, a solvent that has a flash point of 40 degrees C or more and a boiling point of 120 degrees C or more is selected. At this time, the temperature of the heater is set to, for example, 100 degrees C. The solvent desirably has low solvency because the solvent having high solvency may damage the ink placement device 63. However, the ink 41 used in the printing apparatus 100 is not limited to the above-described ink.

### Transfer Step Op3

In the transfer step OP3, in a case where printing is performed by use of the printing pad 10 of which the surface has a curved surface such as a parabolic surface shape, the printing pad 10 is pressed against the printing original plate 50 from the apex, and therefore, the print image is transferred to the printing pad 10. As described above, an ink drying step OP6 of drying the ink 41 transferred to the printing pad 10 may be performed after the transfer step OP3. The ink drying step OP6 corresponds to a drying step S3 described in operation of the printing apparatus 100 described below.

### Pressing Step Op4

In the pressing step OP4, the printing pad 10 is pressed against the printed matter 70. The ink 41 adhering to the surface of the printing pad 10 is transferred to the surface of the printed matter 70. In a case where printing is performed by use of the printing pad 10, the printing can be performed by aligning the printing pad 10 with the shape of the surface of the printed matter 70 even though the surface of the printed matter 70 has a curved surface. Before the pressing step OP4 is performed, the base body 76 is positioned onto the printing stage 87. The base body 76 is positioned by use of a jig 89. In a case where the pressing step is performed on the printed matter 70 a plurality of times, the jig 89 is preferably changed such that a posture of the printed matter 70 is changed for each time, and the printed matter 70 is preferably adjusted such that the printing pad 10 is pressed against the surface of the base body 76 at a desired position and angle.

### Fixing Step Op5

In a fixing step OP5, the ink 41 transferred onto the surface of the printed matter 70 in the pressing step OP4 is fixed. In a case of using the UV ink as the ink 41, an ultraviolet irradiation device (not illustrated) may irradiate the surface of the printed matter 70 with ultraviolet rays and thus may cure the ink 41. Alternatively, the surface of the printed matter 70 may be irradiated with an electron beam in place of the ultraviolet rays. In a case where the shape of the printed matter 70 includes a curved surface, an ultraviolet irradiation device 80 that can apply ultraviolet rays along the surface having the curved surface is desirably used.

In the fixing step OP5, a means for curing the ink 41 is not limited to irradiation with the ultraviolet rays or the electron beam. Other means may also be used. For example, the ink 41 may be cured by being heated by a heater, or may be cured by being dried by blown air. Further alternatively, the ink 41 may be cured by natural drying.

### Operation of Printing Apparatus 100

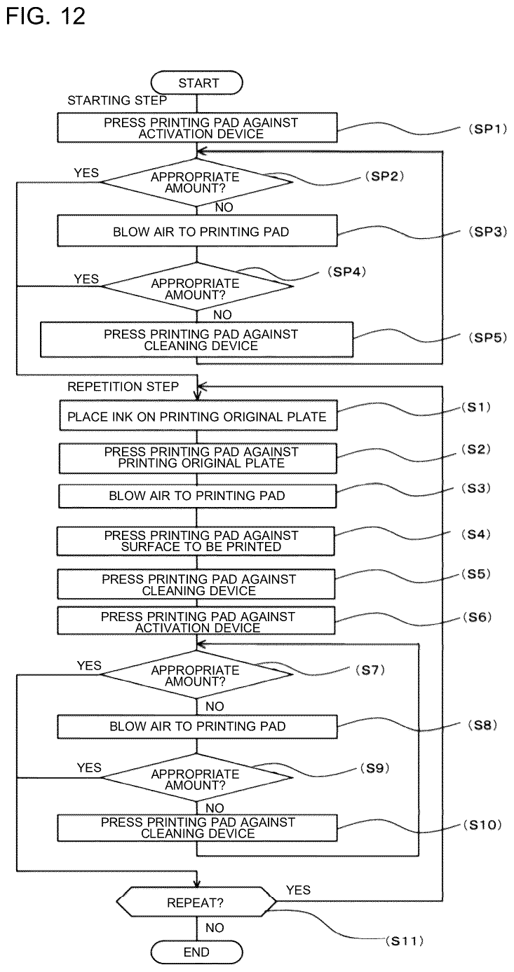

FIG. 12 illustrates a workflow of operation of the printing apparatus 100 according to Embodiment 1. To implement the method of manufacturing the printed matter as illustrated in FIG. 11 described above, the printing apparatus 100 operates in accordance with the workflow illustrated in FIG. 12.

### Starting Step

A starting step is a step performed immediately after the printing apparatus 100 is started up. The surface of the printing pad 10 may not be activated immediately after manufacture of the printed matter is started. Therefore, a step of properly activating the printing surface 4 of the printing pad 10 is performed. After the printing apparatus 100 is started up, the printing apparatus 100 moves the printing pad 10 to above the activation device 61, and moves down the printing pad 10 toward the activation device 61. After the printing surface 4 is pressed against the absorption unit of the activation device 61, and a predetermined range including the printing surface 4 comes into contact with the absorption unit, the printing pad 10 is moved upward. This is referred to as an activation step (SP1). As a result, the liquid such as water and a solvent permeating into the absorption unit of the activation device 61 adheres to or permeate into the printing surface 4 of the printing pad 10. The printing pad 10 includes irregularities on the surface, and the liquid such as water and a solvent permeating into the absorption unit permeates into the irregularities. The step is referred to as a first starting step.

After the first starting step is completed, it is determined whether an amount of liquid adhering to the printing surface 4 of the printing pad 10 is appropriate (SP2). In a case where the amount of liquid adhering to the printing surface 4 is not appropriate (NO in SP2), the printing apparatus 100 performs an air blowing step (SP3). In the air blowing step, the air blowing device 62 blows air to the printing surface 4 of the printing pad 10 and thus removes excess liquid adhering to the printing surface 4. The case where the amount of liquid adhering to the printing surface 4 is not appropriate is a case where the liquid excessively adheres to the printing surface 4. The above-described step is referred to as a second starting step.

After the second starting step is completed, it is determined whether the amount of liquid adhering to the printing surface 4 of the printing pad 10 is appropriate (SP4). In a case where water or a solvent still excessively adheres to the printing surface 4 of the printing pad 10 (NO in SP4), the printing apparatus 100 performs an absorption step (SP5). In the absorption step, the printing apparatus 100 presses the printing surface 4 of the printing pad 10 against the cleaning device 60. As a result, the liquid excessively adhering to the printing surface 4 of the printing pad 10 is removed. The above-described step is referred to as a third starting step.

In a case where the amount of water or a solvent adhering to or permeating into the printing pad 10 is appropriate, execution of one or both of the air blowing step (SP3) and the absorption step (SP5) may be omitted. An execution order of the air blowing step and the absorption step may be changed. Further, the air blowing step (SP3) and the absorption step (SP5) in the starting step may be performed a plurality of times.

### Repetition Step

After the starting step is completed, and the state of the printing surface 4 of the printing pad 10 is properly activated, the step proceeds to a repetition step. The repetition step includes an ink placement step (S1), an ink transfer step (S2), a drying step (S3), a pressing step (S4), a cleaning step (S5), an activation step (S6), an air blowing step (S8), and an absorption step (S10). As illustrated in FIG. 9, the printing apparatus 100 performs the ink placement step (S1), the ink transfer step (S2), the drying step (S3), the pressing step (S4), the cleaning step (S5), the activation step (S6), the air blowing step (S8), and the absorption step (S10) in this order. However, the order of steps in the repetition step is not only limited to this order. For example, after the ink placement step (S1) and the ink transfer step (S2) are completed, the printing apparatus 100 performs the steps from the drying step (S3) to the absorption step (S9). On the other hand, the printing apparatus 100 may perform the ink placement step (S1) of a next cycle in parallel while performing the steps from the drying step (S3) to the absorption step (S9).

The ink placement step (S1) corresponds to the printing original plate creation step OP1 in the method of manufacturing the printed matter illustrated in FIG. 11. The ink transfer step (S2) corresponds to the transfer step OP3 in the method of manufacturing the printed matter illustrated in FIG. 11. Before the pressing step (S4), the drying step (S3) of sending air to the printing surface 4 of the printing pad 10 and thus increasing the viscosity of the ink 41 on the printing surface 4 may be performed. The drying step (S3) is performed in such a manner that air is sent to the printing surface 4 of the printing pad 10 by use of the blower 66 of the printing stage 87. Alternatively, the drying step (S3) may be performed by use of the blower 66A on the surface treatment stage 86. The drying step (S3) may be or may not be performed depending on the viscosity of the ink 41 on the printing original plate 50. The pressing step (S4) corresponds to the pressing step OP4 in the method of manufacturing the printed matter illustrated in FIG. 11. In the case of the printing apparatus 100 according to Embodiment 1, a step of moving the printing pad 10 to above the base body 76 is included between the ink transfer step (S2) and the pressing step (S4). The step including the ink transfer step (S2), the step of moving the printing pad 10 to above the base body 76, and the pressing step (S4) may be referred to as a printing step.

In the repetition step, one print image region 71 is completed every time the pressing step (S4) is performed. For example, in a case of the printed matter 70 illustrated in FIG. 1, the pressing step (S4) is performed four times while the position of the printing pad 10 is changed.

### Cleaning Step

In the cleaning step (S5), the printing surface 4 of the printing pad 10 after the ink 41 is transferred to the surface to be printed is pressed against a flat cleaning surface of the cleaning device 60. The ink 41 remaining on the printing pad 10 is caused to adhere to the cleaning surface. The cleaning surface is made of paper or an adhesive tape, but is not limited to these materials.

### Activation Step, Air Blowing Step, and Absorption Step

The activation step (S6) is a step of the same contents as the contents of the activation step (SP1) in the starting step. The air blowing step (S8) is a step of the same contents as the contents of the air blowing step (SP3) in the starting step. The absorption step (S10) is also a step of the same contents as the contents of the absorption step (SP5) in the starting step. The air blowing step (S8) and the absorption step (S10) are performed depending on an amount of liquid such as water and a solvent adhering to the printing surface 4 of the printing pad 10. One of the air blowing step (S8) and the absorption step (S10) may be omitted, or at least one of the air blowing step (S8) and the absorption step (S10) may be performed a plurality of times. Each of the air blowing step (S8) and the absorption step (S10) is performed depending on the activation state of the printing surface 4 of the printing pad 10 after the state of the printing surface 4 is checked before each of the steps. In a case where the state of the printing surface 4 of the printing pad 10 is checked in a checking step (S7 and S9), and the activation state of the printing surface 4 is proper, it is determined whether the printing is to be performed again in a repetition determination step (S11). In a case where the printing is to be performed again (YES in S11), the steps from the ink placement step (S1) are repeated again. In a case where the printing is not repeated (NO in S11), manufacture of the printed matter is finished.

As described above, the printing apparatus 100 performs the starting step at startup and performs the repetition step thereafter, thereby performing printing on a number of printed matters 70. When the printing pad 10 is in the activated state, the above-described starting step (SP1 to SP5) may be omitted.

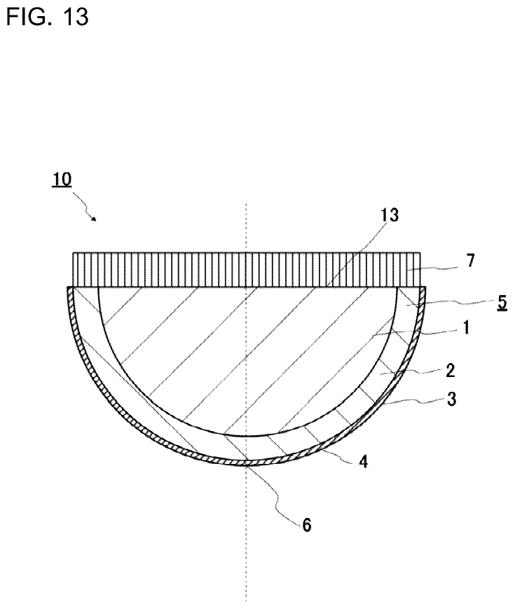

FIG. 13 illustrates a modification of the printing pad 10 used in the printing apparatus 100 of Embodiment 1. The printing pad 10 according to Embodiment 1 may include a protective film layer 3 covering the surface of the base 5. The protective film layer 3 forms an outer surface of the printing surface 4 of the printing pad 10. The protective film layer 3 is formed by, for example, bonding a sheet that is made of a silicone rubber and has a thickness of 0. 5 mm to the surface of the external layer 2. The protective film layer 3 prevents silicone oil contained in the internal soft silicone rubber from oozing to the printing surface 4. The outside surface of the protective film layer 3 is required to have durability against factors that cause scratches and wear because the outside surface of the protective film layer 3 forms the printing surface 4 and is repeatedly pressed against the printing original plate 50 and the surface to be printed. Therefore, the protective film layer 3 is made of a material having higher hardness than the hardness of the external layer 2, and is so thin as to be aligned with the surface to be printed when the printing surface 4 is pressed against the surface to be printed. In Embodiment 1, the protective film layer 3 has a thickness as thin as possible, and preferably has a thickness, for example, within a range from 0.1 mm to 1 mm. The material of the protective film layer 3 is not only limited to the silicone rubber, and the material can be appropriately selected as long as the material enables the protective film layer 3 to be aligned with deformation of the internal layer 1 and the external layer 2. In addition, the protective film layer 3 desirably has sufficient stretchability to be bonded along the surface of the base 5 in a step of bonding the protective film layer 3 to the base 5. The printing pad 10 may further include a multilayer structure. For example, the internal layer 1 or the external layer 2 of the printing pad 10 illustrated in FIG. 13 may be formed such that the internal layer 1 or the external layer 2 has a multilayer structure made of materials different in hardness.

The protective film layer 3 is bonded to the surface of the base 5; however, when damage such as scratches and wear occurs, the protective film layer 3 can be peeled from the surface of the base 5 and replaced with a new protective film layer. The protective film layer 3 is inexpensive as compared with the base 5, and the internal base 5 can be used as it is by replacement of the protective film layer 3. Therefore, updating the protective film layer 3 enables repetitive use of the expensive base 5, which makes it possible to maintain the state of the printing surface 4 of the printing pad 10 in a state suited for printing. Furthermore, the printing apparatus 100 according to Embodiment 1 enables reduction in the cost necessary for printing. In FIG. 10, the base 5 includes the internal layer 1 and the external layer 2, but may include only one internal layer 1. In other words, the protective film layer 3 may be provided on the base 5 including only one internal layer 1. However, in replacement of the protective film layer 3 bonded to the base 5, the base 5 may be damaged by a work of peeling the protective film layer 3, or the surface of the base 5 may be subjected to change in quality such as hardening. Therefore, the base 5 desirably includes a multilayer as illustrated in FIG. 13.

Although the present disclosure is described above with reference to the embodiment, the present disclosure is not only limited to the configuration according to the above-described embodiment. In particular, the combination of components is not only limited to the combination in the embodiment, and can be appropriately changed. Further, it is noted that various modifications, applications, and utilizations made by those skilled in the art as necessary are also included in the spirit (technical scope) of the present disclosure.

### REFERENCE SIGNS LIST

1: internal layer, 2: external layer, 3: protective film layer, 4: printing surface, 5: base, 6: apex, 7: supporting part, 10: printing pad, 11: vertically moving device, 12: horizontally moving device, 13: flat surface, 20: controller, 20 a: calculation device, 20b: storage device, 41: ink, 42: first portion, 43: second portion, 50: printing original plate, 51: placement surface, 60: cleaning device, 61: activation device, 62: air blowing device, 63: ink placement device, 64: roller, 66: blower, 66A: blower, 68: temperature sensor, 70: printed matter, 70a: surface, 70b: surface, 71: print image region, 71A: print image region, 71B: print image region, 71a: print image region, 71b: print image region, 71c: print image region, 72: first region, 72A: first region, 72B: first region, 73: second region, 73A: second region, 73B: second region, 74: peripheral edge, 74A: peripheral edge, 74B: peripheral edge, 75: connection region, 75A: connection region, 75B: connection region, 75a: connection region, 75b: connection region, 76: base body, 80: ultraviolet irradiation device, 85: printing original plate stage, 86: surface treatment stage, 87: printing stage, 100: printing apparatus, H: tangent, L: boundary

1. A printed matter formed by transferring ink placed on a printing surface of a printing pad through pressing the printing surface, the printed matter comprising:
a base body; and
a print image region formed by placing the ink on a surface of the base body,
the print image region including two print image regions disposed adjacent to each other,
each of the two print image regions including an edge facing an other of the
each of the two print image regions including a first region and a second region different in arrangement structure of the ink,
the first region having an amount of the ink greater than an amount of the ink in the second region,
the edge of each of the two print image regions being disposed such that the edge avoids the first region.

2. (canceled)

3. A printed matter formed by transferring ink placed on a printing surface of a printing pad through pressing the printing surface, the printed matter comprising:
a base body; and
a print image region formed by placing the ink on a surface of the base body,
the print image region including two print image regions disposed adjacent to each other,
each of the two print image regions including an edge facing an other of the two print image regions,
the edge of each of the two print image regions being disposed within a range of the other of the two print image regions,
each of the two print image regions including first regions and second regions different in arrangement structure of the ink,
each of the two print image regions having a stripe pattern in which the first regions and the second regions are alternately arranged,
the edge being disposed in one of the first regions and the second regions.

4. A printed matter formed by transferring ink placed on a printing surface of a printing pad through pressing the printing surface, the printed matter comprising:
a base body; and
a print image region formed by placing the ink on a surface of the base body,
the print image region including two print image regions disposed adjacent to each other,
each of the two print image regions including an edge facing an other of the two print image regions,
the edge of each of the two print image regions being disposed within a range of the other of the two print image regions,
each of the two print image regions including a connection region having a predetermined width along the edge,
in the connection region, dot density of the ink per unit area being gradually increased from the edge to a center of each of the two print image regions.

5. The printed matter of claim 4, wherein the connection regions of the two print image regions are disposed such that the connection regions are overlapped with each other.

6. A method of manufacturing a printed matter, the method including transferring ink placed on a printing surface of a printing pad through pressing the printing surface against a surface of a base body, and forming two print image regions at least disposed adjacent to each other on the surface of the base body, each of the two print image regions including an edge facing an other of the two print image regions, the method comprising:
transferring the ink on a printing original plate to the printing surface by pressing the printing surface against the printing original plate on which the ink is placed;
moving the printing pad in which the ink is transferred to the printing surface to above the base body; and
pressing the printing surface against the surface of the base body through forming one of the two print image regions by aligning the printing surface with the surface of the base body and deforming the printing surface,
the transferring, the moving, and the pressing being performed every time each of the two print image regions is formed,
the pressing being performed such that the edge of each of the two print image regions is arranged within a range of the other of the two print image regions,
the pressing being performed such that each of the two print image regions includes a first region and a second region different in arrangement structure of the ink, the first region has an amount of the ink greater than an amount of the ink in the second region, and is surrounded by the second region, and the edge of each of the two print image regions is disposed such that the edge avoids the first region.

7. The printed matter of claim 1, wherein
the respective edges included in the two print image regions disposed adjacent to each other are in contact with each other, and
a boundary between the two print image regions disposed adjacent to each other avoids the first region.

8. The printed matter of claim 3, wherein
the respective edges included in the two print image regions disposed adjacent to each other are in contact with each other, and
a boundary between the two print image regions disposed adjacent to each other is disposed in one of the first regions and the second regions.

9. The printed matter of claim 5, wherein the connection regions of the two print image regions are each sized within a range of 30 mm to 60 mm.

10. The printed matter of claim 1, wherein the edge of each of the two print image regions has a curved shape including irregularities.

11. The printed matter of claim 1, wherein the edge of each of the two print image regions is disposed within a range of the other of the two print image regions.

12. The method of manufacturing a printed matter of claim 6, wherein
in the pressing, the respective edges included in the two print image regions disposed adjacent to each other are in contact with each other, and
the pressing is performed such that a boundary between the two print image regions disposed adjacent to each other avoids the first region.

13. A method of manufacturing a printed matter, the method including transferring ink placed on a printing surface of a printing pad through pressing the printing surface against a surface of a base body, and forming two print image regions at least disposed adjacent to each other on the surface of the base body, each of the two print image regions including an edge facing an other of the two print image regions, the method comprising:
transferring the ink on a printing original plate to the printing surface by pressing the printing surface against the printing original plate on which the ink is placed;
moving the printing pad in which the ink is transferred to the printing surface to above the base body; and
pressing the printing surface against the surface of the base body through forming one of the two print image regions by aligning the printing surface with the surface of the base body and deforming the printing surface,
the transferring, the moving, and the pressing being performed every time each of the two print image regions is formed,
the pressing being performed such that the edge of each of the two print image regions is arranged within a range of the other of the two print image regions,
the pressing being performed such that each of the two print image regions includes a first region and a second region different in arrangement structure of the ink, each of the two print image regions has a stripe pattern in which the first regions and the second regions are alternately arranged, and the edge of each of the two print image regions is disposed in one of the first regions and the second regions.

14. The method of manufacturing a printed matter of claim 13, wherein
in the pressing, the respective edges included in the two print image regions disposed adjacent to each other are in contact with each other, and
the pressing is performed such that a boundary between the two print image regions disposed adjacent to each other is disposed in one of the first regions and the second regions.

15. A method of manufacturing a printed matter, the method including transferring ink placed on a printing surface of a printing pad through pressing the printing surface against a surface of a base body, and forming two print image regions at least disposed adjacent to each other on the surface of the base body, each of the two print image regions including an edge facing an other of the two print image regions, the method comprising:
transferring the ink on a printing original plate to the printing surface by pressing the printing surface against the printing original plate on which the ink is placed;
moving the printing pad in which the ink is transferred to the printing surface to above the base body; and
pressing the printing surface against the surface of the base body through forming one of the two print image regions by aligning the printing surface with the surface of the base body and deforming the printing surface,
the transferring, the moving, and the pressing being performed every time each of the two print image regions is formed,
the pressing being performed such that the edge of each of the two print image regions is arranged within a range of the other of the two print image regions,
the pressing being performed such that each of the two print image regions includes a connection region having a predetermined width along the edge,
in the connection region, dot density of the ink per unit area being gradually increased from the edge to a center of each of the two print image regions.

16. The method of manufacturing a printed matter of claim 15, wherein the pressing is performed such that the connection regions of the two print image regions are disposed such that the connection regions are overlapped with each other.

17. The method of manufacturing a printed matter of claim 16, wherein the pressing is performed such that the connection regions of the two print image regions are each sized within a range of 30 mm to 60 mm.
